(19) United States
(12) Patent Application Publication
(10) Pub. No.: US 2025/0075339 A1
(43) Pub. Date: Mar. 6, 2025

(54) APPARATUS AND METHOD FOR PRODUCTION OF GREEN HYDROGEN USING STEAM GENERATED DURING PRODUCTION OF GREEN AMMONIA

(71) Applicant: ACWA POWER Company, Riyadh (SA)

(72) Inventor: Venkata Krishna VAKACHARLA, Dubai (AE)

(73) Assignee: ACWA POWER Company, Riyadh (SA)

(21) Appl. No.: 18/818,125

(22) Filed: Aug. 28, 2024

Related U.S. Application Data
(60) Provisional application No. 63/580,926, filed on Sep. 6, 2023.

(51) Int. Cl. C25B 1/04; C01C 1/00; C01C 1/04

(52) U.S. Cl. CPC C25B 1/04; C01C 1/003; C01C 1/04

(57) ABSTRACT

An apparatus and a method for production of green hydrogen using steam generated during the production of green ammonia controls: (i) a supply of steam from an ammonia reactor unit to a heat exchange unit at a first timestamp; (ii) the heat exchange unit to extract a pre-determined amount of heat from steam, and to transfer a pre-determined amount of heat to a water supply unit. The apparatus also controls the water supply unit to increase the water temperature from a first temperature value to a second temperature value using a transferred, pre-determined amount of heat. The apparatus also controls the water supply to an electrolyzer unit. The apparatus also controls the ammonia reactor unit to produce green ammonia and steam at a second timestamp using produced green hydrogen. The apparatus also controls an ammonia storage unit to store produced green ammonia at the first and second timestamps.

### CROSS-REFERENCE TO RELATED APPLICATION

This application claims priority to U.S. Provisional Patent Application Ser. No. 63/580,926, filed Sep. 6, 2023 and entitled APPARATUS AND METHOD FOR PRODUCTION OF GREEN HYDROGEN USING STEAM GENERATED DURING PRODUCTION OF GREEN AMMONIA, the disclosure of which is incorporated herein by reference.

### TECHNOLOGICAL FIELD

The present disclosure generally relates to production of green hydrogen, and more particularly relates to an apparatus and a method for the production of green hydrogen using steam generated during the production of green ammonia.

### BACKGROUND

Green ammonia refers to ammonia that is produced using renewable energy sources instead of conventional fossil fuels. Traditional ammonia production process relies on Haber-Bosch process which combines nitrogen from the air with hydrogen typically derived from natural gas, resulting in carbon dioxide emissions. In contrast, the green ammonia production aims to eliminate these emissions by utilizing hydrogen produced through water electrolysis powered by renewable energy sources like wind solar or hydropower. In such a process, water splits into hydrogen and oxygen using electricity from renewable sources ensuring that the hydrogen used in the ammonia synthesis is carbon free.

The production of green ammonia involves integrating renewable energy with advanced electrolyzer to generate hydrogen in a sustainable manner. The hydrogen is then fed into Haber-Bosch process to synthesize ammonia but without the associated carbon footprint of traditional methods. By leveraging renewable energy, green ammonia can serve as a clean fuel, carbon-neutral fertilizer, and a crucial component in reducing greenhouse gas emission across various industries.

During the production of green ammonia using the Haber-Bosch process generates an enormous amount of steam as a by-product that is traditionally utilized for power generation. However, due to mechanical and thermodynamic losses, more than half of this steam is ultimately wasted. Therefore, there is a need for minimizing such losses effectively and efficiently, thereby allowing optimal utilization of the generated steam during the production of green ammonia.

### BRIEF SUMMARY

The present invention discloses an apparatus and a method for the production of green hydrogen using steam generated during the production of green ammonia, thereby optimizing the utilization of the steam generated during the production of green ammonia.

In one aspect, an apparatus for producing green hydrogen using steam generated during the production of green ammonia is provided. The apparatus may include at least one non-transitory memory configured to store computer-executable instructions and at least one processor to execute the computer-executable instructions. The processor may be configured to control a supply of steam from an ammonia reactor unit to a heat exchange unit at a first timestamp. The ammonia reactor unit may be configured to produce green ammonia and steam. The processor may be further configured to control the heat exchange unit to extract a pre-determined amount of heat from the steam and transfer the extracted pre-determined amount of heat to a water supply unit. The processor may be further configured to control the water supply unit to increase a temperature of the water in the water supply unit from a first temperature value to a second temperature value using the transferred pre-determined amount of heat. The processor may be further configured to control a supply of the water from the water supply unit to an electrolyzer unit. The electrolyzer unit is configured to split the water to produce green hydrogen and green oxygen. The processor may be further configured to control the ammonia reactor unit to produce the green ammonia and the steam at a second timestamp using the produced green hydrogen. The produced steam may be fed into the heat exchange unit at the second timestamp. The processor may be further configured to control an ammonia storage unit to store the produced green ammonia.

In one embodiment, the processor may be further configured to execute the computer-executable instructions to control the electrolyzer unit to split the water to produce the green hydrogen and the green oxygen by electrolyzing the water at an electrolyzing temperature.

In one embodiment, the processor may be further configured to execute the computer-executable instructions to control the air separation unit to produce nitrogen from air. The air includes at least one of nitrogen, oxygen and argon.

In one embodiment, the apparatus may further include a nitrogen storage unit. The processor may be further configured to execute the computer-executable instructions to control the nitrogen storage unit to store the produced nitrogen.

In one embodiment, the processor may be further configured to execute the computer-executable instructions to control the nitrogen storage unit to feed the stored nitrogen to the ammonia reactor unit to produce the green ammonia.

In one embodiment, the processor may be further configured to execute the computer-executable instructions to control the ammonia reactor unit to produce the green ammonia using produced nitrogen from an air separation unit and the produced green hydrogen from the electrolyzer unit.

In one embodiment, the produced green ammonia corresponds to a primary product and the produced steam corresponds to a by-product of the ammonia reactor unit.

In one embodiment, the water supply unit further includes a demineralizer unit. The processor is further configured to execute the computer-executable instructions to control the demineralizer unit to perform demineralization of the water by removing one or more impurities from the water before the supply of water from the water supply unit to the electrolyzer unit.

In one embodiment, a temperature of the steam is decreased from a third temperature value to a fourth temperature value after the extraction of the pre-determined amount of heat to produce water. The produced water is supplied to the water supply unit.

In one embodiment, the processor may be further configured to execute the computer-executable instructions to control the water supply unit to store the produced water.

In another aspect, a method for producing green hydrogen from steam using steam is provided. The method may include controlling a supply of steam from an ammonia reactor unit to a heat exchange unit at a first timestamp. The ammonia reactor unit is configured to produce green ammonia and steam. The method may include controlling the heat exchange unit to extract a pre-determined amount of heat from the steam and transfer the extracted pre-determined amount of heat to a water supply unit. The method may include controlling the water supply unit to increase a temperature of the water in the water supply unit from a first temperature value to a second temperature value using the transferred pre-determined amount of heat. The method may include controlling a supply of the water from the water supply unit to an electrolyzer unit. The electrolyzer unit is configured to split the water to produce green hydrogen and green oxygen. The method may include controlling the ammonia reactor unit to produce the green ammonia and the steam at a second timestamp using the produced green hydrogen. The produced steam is fed into the heat exchange unit at the second timestamp. The method may include controlling an ammonia storage unit to store the produced green ammonia.

In one method embodiment, the method may include controlling the electrolyzer unit to split the water to produce the green hydrogen and the green oxygen by electrolyzing the water at an electrolyzing temperature.

In one method embodiment, the method may include controlling an air separation unit to produce nitrogen from air. The air includes at least one of nitrogen, oxygen and argon.

In one method embodiment, the method may include controlling a nitrogen storage unit to store the produced nitrogen.

In one method embodiment, the method may include controlling the nitrogen storage unit to feed the stored nitrogen to the ammonia reactor unit to produce the green ammonia.

In one method embodiment, the method may include controlling the ammonia reactor unit to produce the green ammonia using produced nitrogen from an air separation unit and the produced green hydrogen from the electrolyzer unit.

In one method embodiment, the produced green ammonia corresponds to a primary product and the produced steam corresponds to a by-product, of the ammonia reactor unit.

In one method embodiment, a temperature of the steam is decreased from a third temperature value to a fourth temperature value after the extraction of the pre-determined amount of heat to produce water. The produced water is supplied to the water supply unit.

In one method embodiment, the method may include controlling a demineralizer unit to perform demineralization of the water by removing one or more impurities from the water before the supply of water from the water supply unit to the electrolyzer unit.

In yet another aspect, a non-transitory computer-readable medium having stored thereon, computer-executable instructions that when executed by a processor of an apparatus, causes the processor to execute operations for producing green hydrogen using steam generated during the production of green ammonia. The operations may include controlling a supply of steam from an ammonia reactor unit to a heat exchange unit at a first timestamp. The ammonia reactor unit is configured to produce green ammonia and the steam. The operations may include controlling the heat exchange unit to extract a pre-determined amount of heat from the steam and transfer the extracted pre-determined amount of heat to a water supply unit. The operations may include controlling the water supply unit to increase a temperature of the water in the water supply unit from a first temperature value to a second temperature value using the transferred pre-determined amount of heat. The operations may include controlling a supply of the water from the water supply unit to an electrolyzer unit. The electrolyzer unit is configured to split the water to produce green hydrogen and green oxygen. The operations may include controlling the ammonia reactor unit to produce the green ammonia and the steam at a second timestamp using the produced green hydrogen. The produced steam is fed into the heat exchange unit at the second timestamp. The operations may include controlling an ammonia storage unit to store the produced green ammonia.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Having thus described example embodiments of the invention in general terms, reference will now be made to the accompanying drawings, which are not necessarily drawn to scale, and wherein:

FIG. 1 is a diagram that illustrates a network environment in which an apparatus for production of green hydrogen using steam generated during the production of green ammonia is implemented, in accordance with the present disclosure;

FIG. 2 illustrates a block diagram of the apparatus of FIG. 1, in accordance with an embodiment of the disclosure;

FIG. 3 is a schematic block diagram that illustrates an exemplary block diagram of a nitrogen storage unit, in accordance with the present disclosure

FIG. 4 illustrates an exemplary schematic diagram of the apparatus for production of green hydrogen using steam generated during the production of green ammonia, in accordance with the present disclosure; and

FIG. 5 is a flowchart that illustrates an exemplary method for production of green hydrogen using steam generated during the production of green ammonia, in accordance with the present disclosure.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, systems and methods are shown in block diagram form only in order to avoid obscuring the present disclosure.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

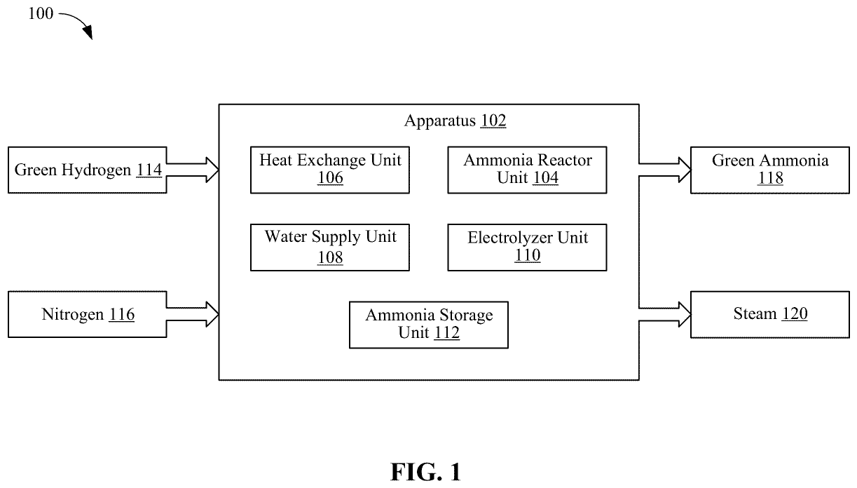

The embodiments are described herein for illustrative purposes and are subject to many variations. It may be understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description may be for convenience only and has no legal or limiting effect. Turning now to FIG. 1-FIG. 5, a brief description concerning the various components of the present disclosure will now be briefly discussed. Reference will be made to the figures showing various embodiments of an apparatus for production of green hydrogen using steam that may have been generated during production of green ammonia previously.

FIG. 1 is a diagram that illustrates a network environment in which an apparatus for production of green hydrogen using steam generated during the production of green ammonia is implemented, in accordance with the present disclosure. With reference to FIG. 1, there is shown a network environment 100. The network environment 100 may include an apparatus 102 which may be used for production of green hydrogen. The apparatus 102 may include an ammonia reactor unit 104, a heat exchange unit 106, a water supply unit 108, an electrolyzer unit 110, and an ammonia storage unit 112. The network environment 100 may further include green hydrogen 114, nitrogen 116, green ammonia 118, and steam 120.

The apparatus 102 may be designed to perform operations for production of the green hydrogen 114. Specifically, the apparatus 102 focuses on steam recovery as well as steam utilization in a process of production of green ammonia 118 to produce the green hydrogen 114. The apparatus 102 may employ a series of operations on the nitrogen 116 and the green hydrogen 114 to produce the green ammonia 118 and the steam 120. Thereafter, the apparatus 102 may utilize the produced steam 120 during the production of the green ammonia 118 to produce the green hydrogen 114. In an embodiment, the apparatus 102 may be configured to control the ammonia reactor unit 104 to produce the green ammonia 118 and the steam 120. Thereafter, the apparatus 102 may be configured to control a supply of the steam 120 from the ammonia reactor unit 104 to the heat exchange unit 106 at a first timestamp. Further, the apparatus 102 may be configured to control the heat exchange unit 106 to extract a pre-determined amount of heat from the steam 120 and transfer the extracted pre-determined amount of heat to a water supply unit 108. The transferred pre-determined amount of heat may facilitate to increase a temperature of the water in the water supply unit 108 from a first temperature value to a second temperature value. As a result of such extraction of the pre-determined amount of heat from the steam 120, a temperature of the steam 120 may decrease from a third temperature value to a fourth temperature value. This may result in condensation of the steam 120 into the water. Further, this water may be fed into the water supply unit 108. Thereafter, the apparatus 102 may control a supply of the water from the water supply unit 108 to the electrolyzer unit 110 configured to split the water to produce the green hydrogen 114 and green oxygen.

Further, the apparatus 102 may be configured to control the ammonia reactor unit 104 to produce the green ammonia 118 and the steam 120 at a second timestamp using the produced green hydrogen 114. This produced steam 120 may be fed into the heat exchange unit 106 at the second timestamp, thereby facilitating the production of the green ammonia 118 using the produced green hydrogen 114. Thereafter, the apparatus 102 may be configured to control the ammonia storage unit 112 to store the produced green ammonia.

The ammonia reactor unit 104 may correspond to a mechanical device designed to produce the green ammonia 118 by employing the Haber-Bosch process. Further, the ammonia reactor unit 104 may include a high pressure and high temperature reactor vessel, thereby facilitating the synthesis reaction between the nitrogen 116 and the green hydrogen 114 under high pressure and temperature in presence of a catalyst to produce the green ammonia 118. The catalyst used in the chemical reaction may maximize the conversion of the nitrogen 116 and the green hydrogen 114 into the green ammonia 118, thereby ensuring a high yield of green ammonia 118. In an example, the catalyst may correspond to iron with promotor elements like potassium and aluminum oxide. By way of an example and not limitation, the ammonia reactor unit 104 maximizes the conversion of the nitrogen 116 and the green hydrogen 114 into green ammonia 118, operating under high pressure of around 100-300 bar pressure, and a high temperature range between 300-500 degree Celsius. The ammonia reactor unit 104 may further include various systems for feeding gases, removing heat generated by an exothermic reaction, and separating and recycling unreacted gases. In an example, the ammonia reactor unit 104 may include, but are not limited to, a natural gas-based ammonia reactor, a coal-based ammonia reactor, and a renewable hydrogen-based ammonia reactor.

The heat exchange unit 106 corresponds to a device that may be designed to efficiently transfer the heat from one fluid (for example, liquid or gas) to another, without mixing both fluids. This may enable transfer of thermal energy for heating or cooling purposes. The heat exchange unit 106 includes components for example, but not limited to, tubes, plates, or fins, which facilitates an efficient transfer of thermal energy. The two fluids may flow through separate channels within the heat exchange unit, thereby allowing the heat to pass through one fluid (such as a hot fluid) to another (such as a cold fluid). The heat exchange unit 106 may be essential for improving energy efficiency and maintaining optimal operating temperature in various systems. Further, the heat exchange unit 106 may be used in a variety of applications including, but not limited to, chemical processing, heating, cooling, air conditioning systems, refrigeration, and power plants.

The water supply unit 108 refers to a water storage facility designed for supplying water to the heat exchange unit 106. The water supply unit 108 may include components for example, but is not limited to pumps, pipes, storage tanks, and treatment facilities (like, a demineralizer unit). In an example, the water supply unit 108 may be configured to increase the temperature of the water in the eater supply unit from a first temperature value to a second temperature value before feeding the water to the heat exchange unit 106. This may facilitate effective transfer of the thermal energy within the heat exchange unit 106.

The electrolyzer unit 110 may use electrolysis for the production of green hydrogen 114 from renewable resources. The electrolysis may be a process that may use electricity to split water into hydrogen and oxygen at an electrolyzing temperature. The electrolyzing temperature may be the temperature at which a molecule of water (H₂O) may be broken into one hydrogen (H₂) molecule and one oxygen atom. For example, the electrolyzing temperature for the water is 85 degrees Celsius. In operation, the electrolyzer unit 110 may receive the water from the water supply unit 108 (that may be produced using the steam 120 during the production of the green ammonia 118) to produce the green hydrogen 114, and an electric current may be passed through the water to initiate different reactions (e.g., an oxidation reaction and/or a reduction reaction) at different electrodes (e.g., an anode and/or a cathode) of the electrolyzer unit 110. For example, at the anode, the oxidation reaction may take place the causing electrolyzer unit 110 to produce oxygen. Further, at the cathode, the reduction reaction may take place causing the electrolyzer unit 110 to produce green hydrogen (H₂) in a gaseous form. The green hydrogen 114 generated during electrolysis may be collected separately from the oxygen. Since hydrogen gas is lighter than the air, it can be collected by displacement or through a gas-collecting apparatus. The electrolyzer unit 110 functions in different ways, mainly due to the different types of electrolyte material involved and the ionic species it conducts.

The ammonia storage unit 112 may correspond to a storage container specifically designed to store fluid, for example, liquid or gas. This may allow safe storage of the fluid, thereby preventing leaks or releases of the fluid. Specifically, the ammonia storage unit 112 may be designed to safely store the green ammonia 118. Examples of the ammonia storage unit 112 may include, but are not limited to, an ammonia storage tank, an ammonia refrigerated storage tank, and an ammonia transport container.

Typically, the green ammonia 118 may be a vital industry chemical and may serve as a precursor for the production of various products such as fertilizers, plastics, cleaning agents, and the like which aids the increasing demand for the green ammonia 118. Traditionally, the green ammonia 118 may be produced based on a chemical reaction between the hydrogen and the nitrogen at an extremely high pressure (e.g., 140-250 bars) and an extremely high temperature (e.g., around 350 degrees Celsius) in the presence of a suitable catalyst. Usually, the green ammonia 118 may be produced at a large scale using the Haber-Bosch process. The Haber-Bosch process involves an exothermic reaction between the hydrogen and the nitrogen to produce the green ammonia 118. Such chemical reaction between nitrogen and hydrogen requires an ample amount of heat and an ample amount of pressure to facilitate an efficient production of the green ammonia 118. Further, the chemical reaction in the Haber-Bosch process conducted in the ammonia reactor unit 104 produces an enormous amount of steam 120 during production of the green ammonia 118 that may remain unutilized.

To overcome the problem associated with utilization of the produced steam 120 during the production of the green ammonia 118, the present disclosure provides the apparatus 102 for the production of green hydrogen 114 efficiently and economically. The disclosed apparatus 102 may focus on the recovery of the steam 120 as well as the utilization of the steam 120 in the process for the production of the green ammonia 118.

In operation, the apparatus 102 may control a supply of the steam 120 from the ammonia reactor unit 104 to the heat exchange unit 106 at a first timestamp. The ammonia reactor unit 104 may be configured to produce the steam 120 as a byproduct during the production of the green ammonia 118. Further, the apparatus 102 may be configured to control the heat exchange unit 106 to extract a pre-determined amount of heat from the steam 120 and transfer the extracted pre-determined amount of heat to a water supply unit 108. The transferred pre-determined amount of heat may facilitate an increase in the temperature of the water stored in the water supply unit 108 from a first temperature value to a second temperature value. As a result of such extraction of the pre-determined amount of heat from the steam 120, the temperature of the steam 120 may decrease from a third temperature value to a fourth temperature value. This may result in condensation of the steam 120 into the water that may be fed into the water supply unit 108. Thereafter, the apparatus 102 may control a supply of the water from the water supply unit 108 to the electrolyzer unit 110 that may be configured to split the water to produce the green hydrogen 114 and the green oxygen.

Further, the apparatus 102 may be configured to control the ammonia reactor unit 104 to produce the green ammonia 118 and the steam 120 at a second timestamp using the produced green hydrogen 114. This produced steam 120 may be fed into the heat exchange unit 106 at the second timestamp, thereby facilitating the production of the green ammonia 118 using the produced green hydrogen 114. Thereafter, the apparatus 102 may be configured to control the ammonia storage unit 112 to store the green ammonia 118 produced at the first timestamp and at the second timestamp. The ammonia storage unit 112 may facilitate safe handling and efficient storage of the green ammonia 118 for various industrial and agricultural applications.

Typically, the production of green ammonia 118 may be facilitated at a temperature nearly equal to 350 degrees Celsius. While in operation, the apparatus 102 may control the ammonia reactor unit 104 to produce the green ammonia 118 and the steam 120. In such a scenario more than half of the produced steam 120 may be released as the by-product during the production of green ammonia 118. Such produced steam 120 may be wasted due to mechanical and thermodynamic losses. To mitigate such a wastage of the produced steam 120, the present disclosure provides an apparatus that focuses on the utilization of the steam generated during the production of green ammonia 118. The disclosed apparatus 102 incorporates techniques to enhance the utilization of the steam 120 by reusing the steam 120 to produce green hydrogen 114 that can be eventually used to produce green ammonia 118 again. This may allow the entire process of the production of green ammonia 118 more sustainable and efficient. Specifically, the steam 120 released as the by-product during the production of green ammonia 118 may be converted into green hydrogen 114 which is again used in the production of green ammonia 118 through a steam recovery and utilization mechanism (for example, by using the heat exchange unit 106, the water supply unit 108, and the electrolyzer unit 110).

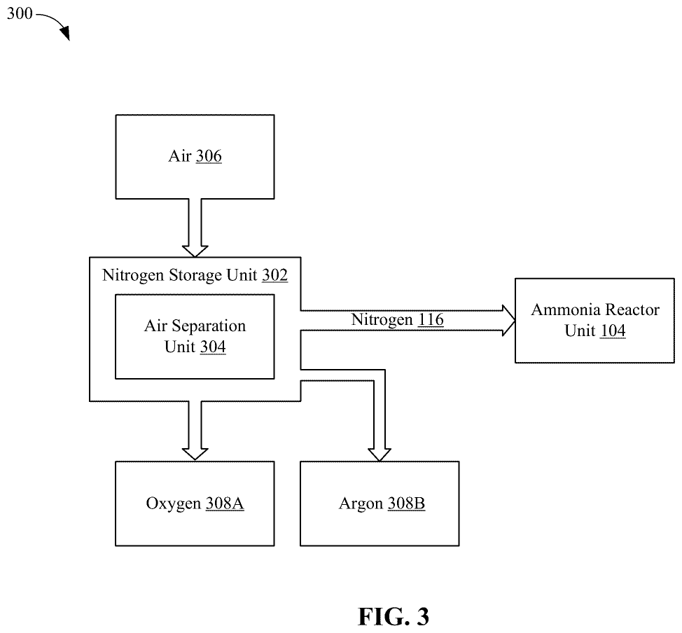

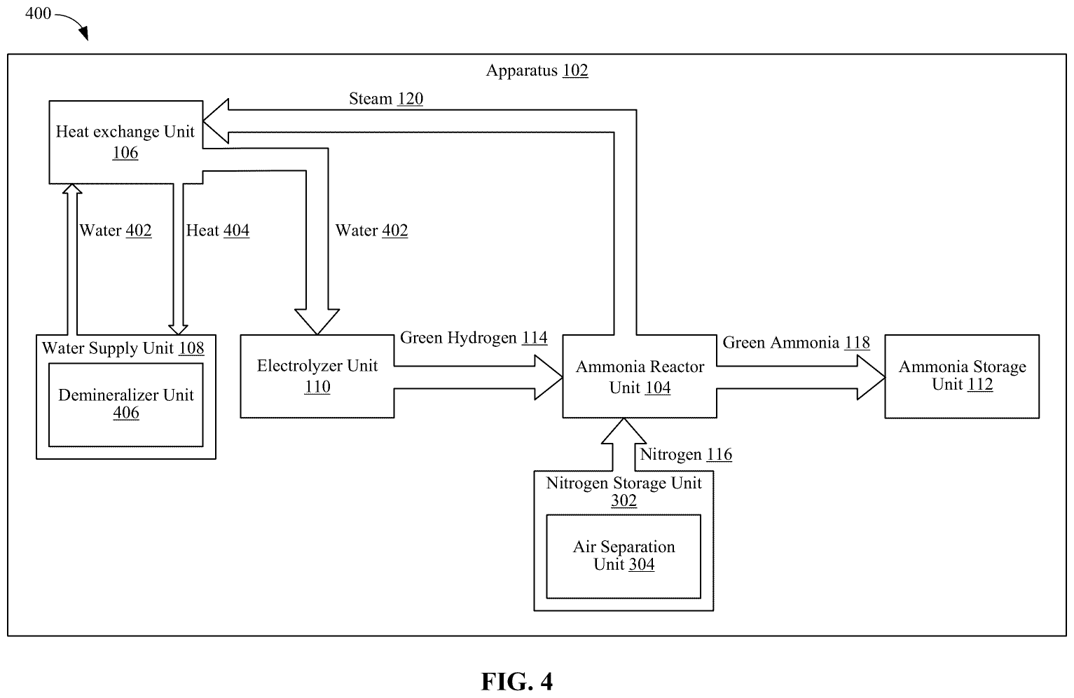

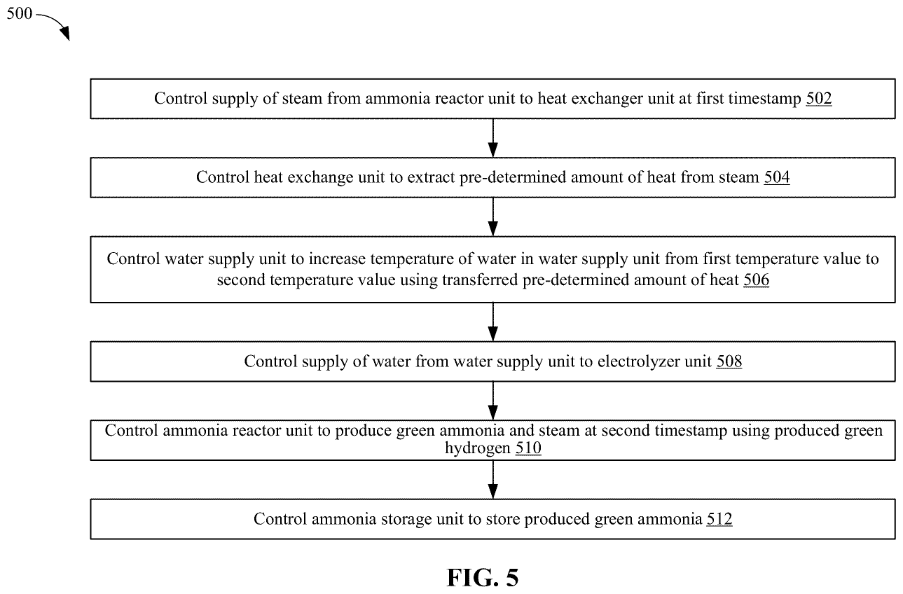

The functions or operations executed by the apparatus 102 are described in detail, for example, in FIG. 3, FIG. 4, and FIG. 5.

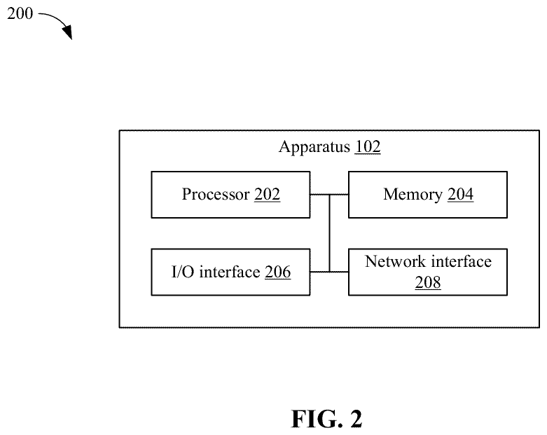

FIG. 2 illustrates a block diagram of the apparatus of FIG. 1, in accordance with an embodiment of the disclosure. FIG. 2 is explained in conjunction with FIG. 1. In FIG. 2, there is shown the block diagram 200 of the apparatus 102. The apparatus 102 may include at least one processor (referred to as a processor 202, hereinafter), at least one non-transitory memory (referred to as a memory 204, hereinafter), an input/output (I/O) interface 206, and a network interface 208. The processor 202 may be connected to the memory 204, the I/O interface 206, and the network interface 208 through one or more wired or wireless connections. Although in FIG. 2, it is shown that the apparatus 102 includes the processor 202, the memory 204, the I/O interface 206, and the network interface 208 however, the disclosure may not be so limiting and the apparatus 102 may include fewer or more components to perform the same or other functions of the apparatus 102.

The processor 202 of the apparatus 102 may be configured to perform one or more operations associated with the production of the green hydrogen 114 using the steam 120 generated during the production of the green ammonia 118. The processor 202 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application-specific integrated circuit), an FPGA (field programmable gate array), a microcontroller unit (MCU), a hardware accelerator, a special-purpose computer chip, or the like. As such, in some embodiments, the processor 202 may include one or more processing cores configured to perform independently. A multi-core processor may enable multiprocessing within a single physical package. Additionally, or alternatively, the processor 202 may include one or more processors configured in tandem via the bus to enable independent execution of instructions, pipelining, and/or multithreading. Additionally, or alternatively, the processor 202 may include one or more processors capable of processing large volumes of workloads and operations to provide support for big data analysis. In an example embodiment, the processor 202 may be in communication with the memory 204 via a bus for passing information among components of the apparatus 102.

For example, when the processor 202 may be embodied as an executor of software instructions, the instructions may specifically configure the processor 202 to perform the algorithms and/or operations described herein when the instructions are executed. However, in some cases, the processor 202 may be a processor-specific device (for example, a mobile terminal or a fixed computing device) configured to employ an embodiment of the present disclosure by further configuration of the processor 202 by instructions for performing the algorithms and/or operations described herein. The processor 202 may include, among other things, a clock, an arithmetic logic unit (ALU), and logic gates configured to support the operation of the processor 202. The communication network may be accessed using the network interface 208 of the apparatus 102.

The memory 204 may be non-transitory and may include, for example, one or more volatile and/or non-volatile memories. In other words, for example, the memory 204 may be an electronic storage device (for example, a computer readable storage medium) comprising gates configured to store data (for example, bits) that may be retrievable by a machine (for example, a computing device like the processor 202). The memory 204 may be configured to store information, data, content, applications, instructions, or the like, for enabling the apparatus 102 to carry out various functions in accordance with an example embodiment of the present disclosure. For example, the memory 204 may be configured to buffer input data for processing by the processor 202. As exemplified in FIG. 2, the memory 204 may be configured to store instructions for execution by the processor 202. As such, whether configured by hardware or software methods, or by a combination thereof, the processor 202 may represent an entity (for example, physically embodied in circuitry) capable of performing operations according to an embodiment of the present disclosure while configured accordingly. Thus, for example, when the processor 202 is embodied as an Application Specific Integrated Circuit (ASIC), Field Programmable Gate Array (FPGA), or the like, the processor 202 may be specifically configured hardware for conducting the operations described herein.

In some example embodiments, the I/O interface 206 may communicate with the apparatus 102 and display the input and/or output of the apparatus 102. As such, the I/O interface 206 may include a display device and, in some embodiments, may also include a keyboard, a mouse, a touch screen, touch areas, soft keys, or other input/output mechanisms. In one embodiment, the apparatus 102 may include a user interface circuitry configured to control at least some functions of one or more I/O interface elements such as a display and, in some embodiments, a plurality of speakers, a ringer, one or more microphones and/or the like. The processor 202 may be configured to control one or more functions of one or more I/O interface 206 elements through computer program instructions (for example, software and/or firmware) stored on the memory 204 accessible to the processor 202.

The network interface 208 may include the input interface and output interface for supporting communications to and from the apparatus 102 or any other component with which the apparatus 102 may communicate. The network interface 208 may be any means such as a device or circuitry embodied in either hardware or a combination of hardware and software that is configured to receive and/or transmit data to/from a communications device in communication with the apparatus 102. In this regard, the network interface 208 may include, for example, an antenna (or multiple antennae) and supporting hardware and/or software for enabling communications with a wireless communication network. Additionally, or alternatively, the network interface 208 may include the circuitry for interacting with the antenna(s) to cause transmission of signals via the antenna(s) or to handle receipt of signals received via the antenna(s). In some environments, the network interface 208 may alternatively or additionally support wired communication. As such, for example, the network interface 208 may include a communication modem and/or other hardware and/or software for supporting communication via cable, digital subscriber line (DSL), universal serial bus (USB), or other mechanisms.

FIG. 3 is a schematic block diagram that illustrates an exemplary block diagram of a nitrogen storage unit, in accordance with the present disclosure. FIG. 3 is explained in conjunction with FIG. 1, and FIG. 2. In FIG. 3 there is shown a block diagram 300 depicting the nitrogen storage unit 302. The nitrogen storage unit 302 further includes the air separation unit 304.

In an embodiment, the air separation unit 304 may be an apparatus or a device that may be used to separate the air 306 into its primary constituents such as the nitrogen 116, oxygen 308A, argon 308B, and the like. The most common method for air separation may be fractional distillation performed in a cryogenic production of nitrogen 116. In an embodiment, the air separation unit 304 may utilize a process known as cryogenic distillation to produce the nitrogen 116. The air separation unit 304 may use a multi-column cryogenic distillation process that leverages different boiling points of gases present in the air 306 for achieving air separation. In an example, the air separation unit 304 may use a three-column cryogenic distillation process. Such a process may include cooling at least a fraction of a cleaned and dried feed air 306. In an example, the feed air 306 may be any gas mixture such as, atmospheric air or any other gas mixtures containing at least the nitrogen 116 and oxygen 308A. In an example, the air 306 may further include gases, such as argon 308B. Further, the feed air 306 may be introduced into a high-pressure column after cooling. Thereafter, the feed air 306 may be cleaned, dried and compressed in a conventional manner to remove carbon dioxide and water.

Further, this cleaned, dried, and compressed air 306 may undergo cooling and is fed into a high-pressure column for air separation. This results in a nitrogen-rich vapor stream at the top and an oxygen-rich liquid stream at the bottom. Thereafter, the nitrogen-rich vapor is condensed at the bottom of both low-pressure and intermediate columns, thereby forming a nitrogen-rich liquid. Further, a portion of this nitrogen-rich liquid serves as reflux for the high-pressure column, while the remaining nitrogen-rich liquid may be directed to the low-pressure column. In an example, some of the liquid may be recovered as product, and a fraction of the nitrogen-rich vapor may be recovered as a medium-pressure nitrogen product. Thereafter, the oxygen-rich liquid stream may be cooled and introduced into the intermediate column, thereby producing a top liquid fraction and a bottom liquid fraction. In an example, the overhead of the high-pressure column exchanges heat with the bottom of the low-pressure and intermediate columns. Further, the overhead of the intermediate column exchanges heat with the low-pressure column above its bottom re-boiler, and the intermediate column operates at a pressure lower than the high-pressure column but higher than the low-pressure column.

In an embodiment, the air separation unit 304 may use methods such as, but not limited to, a pressure swing adsorption (PSA) method, and a vacuum pressure swing adsorption (VPSA) method to separate the nitrogen 116 from the air 306. In the PSA process, compressed air 306 is first filtered to remove oil and water impurities. Further, the purified air 306 is then directed to one of two adsorption vessels filled with carbon molecular sieves (CMS). At the entrance of the adsorbent bed, the CMS absorbs remaining impurities like carbon dioxide and moisture. Further, the CMS selectively adsorbs oxygen under high pressure, thereby allowing nitrogen 116 to pass through at the desired purity level. In such an example, while one vessel is producing nitrogen, the other vessel is simultaneously depressurized to release the adsorbed oxygen, which is then vented to the atmosphere. This automatic cycling of adsorption and desorption between the two vessels enables continuous nitrogen production. Further, by adjusting the size of the air compressor and adsorption vessels containing CMS, a wide range of flow and purity combinations can be achieved.

In VPSA process the air is first compressed with a blower, which then flows through the adsorbent bed under pressure. During this stage, the adsorbent selectively captures the nitrogen 116, carbon dioxide, and water from the air 306, allowing the remaining gases to pass through. As a result, the output gas is enriched with oxygen 308A. Next, the pressure is reduced, causing the absorbent to release the captured nitrogen, carbon dioxide, and water, thereby regenerating the adsorbent material. This cycle can be repeated continuously to produce a steady supply of oxygen-rich gas.

Typically, the air separation unit 304 involves several processing steps such as, but not limited to, air compression, purification, cryogenic cooling, and separation to produce nitrogen 116 from the air. In an embodiment, the processor 202 may be configured to control the air separation unit 304 to produce nitrogen 116 from the air 306. Further, the produced nitrogen 116 may be stored in the nitrogen storage unit 302. In another embodiment, the produced nitrogen 116 may be directly transferred to the ammonia reactor unit 104 for the production of the green ammonia 118.

In an exemplary embodiment, in the air separation unit 304 the feed stream (i.e. the air 306) may be compressed to high pressure in a compressor passes through heat exchangers to cool down. The air 306 may further be fed to the distillation columns to produce gaseous oxygen 308A and nitrogen 116. Further, the gaseous oxygen 308A may be used for oxy-fuel combustion, and the nitrogen 116 may be used for liquefaction through a series of heat exchangers and compressions. Additionally, the nitrogen 116 may be stored at 2.26 bar and around −188° C. in a liquid form. Thereafter, the liquid nitrogen 116 may be passed through the heat exchangers, thereby converting into vapor upon absorbing the heat from the heat exchangers. This vaporized nitrogen 116 may be stored in the nitrogen storage unit 302.

In an embodiment, the nitrogen storage unit 302 may correspond to a storage container specifically designed to store fluid, for example, liquid or gas. This may allow safe storage of the fluid, thereby preventing leaks or releases of the fluid. Specifically, the nitrogen storage unit 302 may be designed to safely store the nitrogen 116. Examples of the nitrogen storage unit 302 may include, but are not limited to, a nitrogen storage tank, a nitrogen refrigerated storage tank, and a nitrogen transport container. Further, the nitrogen storage unit 302 may securely store the nitrogen 116. The stored nitrogen 116 may be precisely metered and introduced into the ammonia reactor unit 104, where it combines with green hydrogen 114 to produce green ammonia 118. Thereby, the nitrogen storage unit 302 contributes to the stability and efficiency of the green ammonia 118 production processes by enabling accurate control of reactant ratios.

FIG. 4 illustrates an exemplary schematic diagram of the apparatus for production of green hydrogen using steam generated during the production of green ammonia, in accordance with the present disclosure. FIG. 4 is explained in conjunction with FIG. 1, FIG. 2, and FIG. 3. With reference to FIG. 4, there is shown a schematic diagram 300 of the apparatus 102 for production of the green hydrogen 114. The apparatus 102 may include the ammonia reactor unit 104, the heat exchange unit 106, the water supply unit 108, the electrolyzer unit 110, the ammonia storage unit 112, the nitrogen storage unit 302, and the air separation unit 304. The water supply unit 108 may further include a demineralizer unit 406.

For production of the green ammonia 118, the apparatus 102 may receive the green hydrogen 114 and the nitrogen 116. In an embodiment, the apparatus 102 may include the electrolyzer unit 110 to produce the green hydrogen 114, and the air separation unit 304 to produce the nitrogen 116.

Typically, the production of green ammonia 118 process (also referred to as green ammonia synthesis reaction) involves a chemical reaction between the nitrogen 116 and the green hydrogen 114. The chemical reaction between the nitrogen 116 and the green hydrogen 114 is an exothermic reaction that generates steam 120 as the by-product. Specifically, the steam 120 may be produced as the by-product during the green ammonia synthesis reaction due to the presence of water vapor in the reactants or because of the high-temperature conditions. Additionally, some steam 120 may be intentionally injected into the ammonia reactor unit 104 to help shift the equilibrium toward the production of green ammonia 118. The apparatus 102 may be further configured to utilize the steam 120 generated during the production of green ammonia 118 to produce the green hydrogen 114 that may be again used to produce green ammonia 118.

Such a chemical reaction generates an ample amount of heat and an ample amount of steam 120 to facilitate an efficient production of green ammonia 118 as a by-product. To overcome this issue the present disclosure may incorporate techniques to enhance the utilization of the steam 120 by reusing the steam 120 to produce green hydrogen 114 that can be eventually used to produce the green ammonia 118 again, thereby making the entire process of the production of green ammonia 118 more sustainable and efficient.

In an embodiment, the ammonia reactor unit 104 may be typically designed as a fixed-bed reactor that may be configured to produce the green ammonia 118 based on the chemical reaction between the nitrogen 116 and the green hydrogen 114. The ammonia reactor unit 104 (also called a green ammonia synthesis reactor) may be typically designed as the fixed-bed reactor, where a solid catalyst, usually an iron-based catalyst, may be used to facilitate the chemical reaction between a set of reactants that may include the nitrogen 116 and the green hydrogen 114. In an exemplary embodiment, the ammonia reactor unit 104 may produce the green ammonia 118 at the first temperature based on the chemical reaction performed between the set of reactants. The first temperature may correspond to a temperature value that may be favorable for conducting the chemical reaction for efficient production of green ammonia 118. For example, the first temperature may be around 350° C. In some embodiments, the first temperature may lie within a range (say between 330° C.-500° C.). Further, the set of reactants may be fed into the ammonia reactor unit 104 after the pressure of the set of reactants has been elevated. The chemical reaction between the set of reactants may be performed in the presence of the iron-based catalyst. Inside the ammonia reactor unit 104, the set of reactants, which may include nitrogen and green hydrogen, may come into contact with the catalyst that provides a surface for the chemical reaction to occur. In an example, the nitrogen 116 and the green hydrogen 114 may react to produce green ammonia 118 according to the following reaction:

$${N}_{2} + 3 {H}_{2} \to 2 {NH}_{3} + Heat \qquad ( 1 )$$

In the above reaction (1), two atoms of nitrogen and six atoms of hydrogen may react to produce two molecules of green ammonia 118. The reaction (1) may be an exothermic reaction which means the reaction (1) may generate a significant amount of heat (as the steam 120) during the chemical reaction.

In another embodiment, the ammonia reactor unit 104 may be designed to produce the green ammonia (NH₃) 118 through the chemical process known as the Haber-Bosch process. Examples of the ammonia reactor unit 104 may include, but are not limited to, a natural gas-based ammonia reactor, a coal-based ammonia reactor, and a renewable hydrogen-based ammonia reactor. Further, the ammonia reactor unit 104 may further produce the steam 120 as a by-product.

In an embodiment, the apparatus 102 may be designed to perform the operation of producing the green hydrogen 114. Specifically, the apparatus 102 focuses on utilizing the steam 120 produced during the production of the green ammonia 118 to produce the green hydrogen 114. The apparatus 102 may include multiple units and sub-units that work collectively to produce the green hydrogen 114.

In an operation, the apparatus 102 may control a supply of the steam 120 from the ammonia reactor unit 104 to the heat exchange unit 106 at a first timestamp (say at Time “T1”). The first timestamp (T1) may be the time where the steam 120 that may be generated as the by-product during the chemical reaction performed in the ammonia reactor unit 104 and supplied to the heat exchange unit 106.

The apparatus 102 may control the heat exchange unit 106 to extract a pre-determined amount of heat 404 from the steam 120 and transfer the extracted pre-determined amount of heat 404 to the water supply unit 108. Thereafter, the apparatus 102 may control the water supply unit 108 to increase a temperature of the water 402 in the water supply unit 108 from a first temperature value to a second temperature value using the transferred pre-determined amount of heat 404. In an example, the temperature of the stored water 402 may be increased by the heat exchange unit 106 using the extracted pre-determined amount of heat 404. Specifically, the apparatus 102 may be configured to control the heat exchange unit 106 to raise a temperature of the water 402 in the water supply unit 108 from the first temperature value to the second temperature value using the extracted pre-determined amount of heat 404. Therefore, the disclosed apparatus 102 may utilize the heat 404 from the steam 120 to heat the water 402 that may be used as a precursor for the generation of green hydrogen 114. Specifically, the heat exchange unit 106 may be a critical component that may optimize energy efficiency by leveraging the heat energy contained in the steam 120 emitted as the byproduct during the production of the green ammonia 118.

Due to the extraction of the pre-determined amount of heat 404 from the steam 120, the temperature of the steam 120 may be decreased from the third temperature value to the fourth temperature value. For example, the third temperature value may be the temperature of the steam 120 after the extraction of the pre-determined amount of heat 404, and the fourth temperature value may be the condensation temperature of the water 402 i.e., 212 degrees Fahrenheit or 100 degrees Celsius.

In an example, the apparatus 102 may control the heat exchange unit 106 to reduce the temperature of the steam 120 from the third temperature value to the fourth temperature value to condense the steam 120, thereby producing water 402. Further, the produced water 402 may be supplied to the water supply unit 108 for storage. Therefore, the disclosed apparatus 102 may also reuse the water 402 during the production of green ammonia 118. In an embodiment, the heat exchange unit 106 (also referred to simply as a heat exchanger unit) may be a mechanical device that may be designed to efficiently transfer a pre-determined amount of heat 404 from the steam 120 to the water 402 stored in the water supply unit 108. The steam 120, after the extraction of the pre-determined amount of heat 404, may be condensed into water 402 by decreasing the temperature of the steam 120 from the third temperature value to the fourth temperature value. The produced water 402 may be supplied to the water supply unit 108. Specifically, the heat exchange unit 106 may be a critical component that may optimize energy efficiency by leveraging the heat energy contained in the steam 120 emitted as the byproduct during the production of green ammonia 118.

In an example, the water supply unit 108 may correspond to a water storage unit that may be used to store the water 402. Furthermore, the water supply unit 108 may be used to store the condensed steam (or the produced water 402) received from the heat exchange unit 106. Further, the water supply unit 108 may include the demineralizer unit 406. In an example, the steam 120 may be released from the ammonia reactor unit 104 such that the steam 120 may contain some impurities and mineral content. Further, the water supply unit 108 collects this steam 120 and subject it to the demineralizer unit 406. The apparatus 102 may be further configured to control the demineralizer unit 406 to perform demineralization of the water 402 by removing one or more impurities from the water. Further, the demineralized water 402 may be supplied to the heat exchange unit 106. The heat exchange unit 106 may receive the demineralized water 402 from the water supply unit 108 and transfer it to electrolyzer unit 110.

Further, the apparatus 102 may control a supply of the water 402 from the water supply unit 108 to the electrolyzer unit 110. The electrolyzer unit 110 is configured to split the water 402 to produce green hydrogen 114 and green oxygen. Further, the apparatus 102 may be configured to control the electrolyzer unit 110 to perform one or more processes to produce the green hydrogen 114 and green oxygen. The electrolyzer unit 110 splits the water 402 at the electrolyzing temperature value to produce the green hydrogen 114 and green oxygen. The electrolyzer unit 110 may elevate the temperature of the received water 402 from the second temperature to the electrolyzing temperature. In an example, the one or more processes may be an electrolysis process to produce the green hydrogen 114 by using electricity to split water 402 into green hydrogen 114 and green oxygen is described, for example, in FIG. 1.

In an embodiment, the electrolyzer unit 110 may be configured to produce green hydrogen at the electrolyzing temperature (nearly 85° C.). The electrolyzer unit 110 may be controlled to receive the water 402 from the heat exchange unit 106 and elevate the temperature of the received water 402 from the second temperature to the electrolyzing temperature. The electrolyzing temperature may be the temperature at which a molecule of water (H₂O) may be broken into one green hydrogen (H₂) atom and one oxygen (O₂) atom. The electrolyzer unit 110 may use electrolysis to produce green hydrogen 114. In an example, the electrolyzer unit 110 may be an alkaline electrolyzer unit, a proton exchange membrane electrolyzer unit, a solid oxide electrolyzer unit, a molten carbonate electrolyzer unit, and a solid polymer electrolyte electrolyzer unit.

Further, the produced green hydrogen 114 may be transferred to the ammonia reactor unit 104. Thereafter, the apparatus 102 may control the ammonia reactor unit 104 to produce the green ammonia 118 and the steam 120 at a second timestamp (say at time T2) after the first timestamp (T1) using the produced green hydrogen 114. The second timestamp (T2) may be the time at which the green ammonia 118 and the steam 120 may be produced by using the supplied nitrogen 116 from the nitrogen storage unit 302 and the green hydrogen 114 from the electrolyzer unit 110. In an embodiment, the produced green ammonia 118 corresponds to a primary product and the produced steam 120 corresponds to a by-product, of the ammonia reactor unit 104. The produced steam 120 may be fed into the heat exchange unit 106 at the second timestamp (T2), and the complete process described above may be repeated continuously. This approach may maximize resource utilization, reduce waste, and optimize heat efficiency, thereby showcasing a sustainable solution for the production of green ammonia 118.

The apparatus 102 may control the ammonia storage unit 112 to store the produced green ammonia 118 at the first timestamp (T1) and the second timestamp (T2). In an example, the produced green ammonia 118 may be further stored in large tanks under a controlled environment. In an example, the ammonia storage unit 112 may be further crafted from materials like steel or fiberglass-reinforced plastic as a defense mechanism from corrosive properties of the green ammonia 118. In an example, the ammonia storage unit 112 may include, but is not limited to a tank, a cylinder, and the like. The stored green ammonia 118 may be utilized in making a variety of goods like fertilizers, polymers, and cleaning agents.

FIG. 5 is a flowchart that illustrates an exemplary method for production of green hydrogen using steam generated during the production of green ammonia, in accordance with the present disclosure. FIG. 5 is explained in conjugation with elements of the FIG. 1, FIG. 2, FIG. 3, and FIG. 4. With reference to FIG. 5, there is shown a flowchart 500. The operations of the exemplary method may be executed by any computing system, for example, by the apparatus 102 of FIG. 1 or the processor 202 of FIG. 2. The operation of the flowchart 500 may start at 502.

At 502, a supply of the steam 120 may be controlled from the ammonia reactor unit 104 to the heat exchanger unit 106 at the first timestamp. The ammonia reactor unit 104 is configured to produce green ammonia 118 and the steam 120. In an embodiment, the processor 202 may be configured to control the supply of the steam 120 from the ammonia reactor unit 104 to the heat exchange unit 106 at a first timestamp (T1), wherein the ammonia reactor unit 104 is configured to produce the green ammonia 118 and the steam 120. Details associated with the ammonia reactor unit 104 are provided in FIG. 1, and FIG. 3.

At 504, the heat exchange unit 106 may be controlled to extract a pre-determined amount of heat 404 from the steam 120 and transfer the extracted pre-determined amount of heat 404 to the water supply unit 108. In an embodiment, the processor 202 may be configured to control the heat exchange unit 106 to extract a pre-determined amount of heat 404 from the steam 120 and transfer the extracted pre-determined amount of heat 404 to the water supply unit 108. Details associated with the heat exchange unit 106 are provided in FIG. 1, and FIG. 4.

At 506, the water supply unit 108 may be controlled to increase temperature of water 402 in water supply unit 108 from a first temperature value to second temperature value using the transferred pre-determined amount of the heat 404. In an embodiment, the processor 202 may be configured to control the water supply unit 108 to increase a temperature of the water 402 in the water supply unit 108 from the first temperature value to the second temperature value using the transferred pre-determined amount of heat 404. Details associated with the water supply unit 108 are provided in FIG. 1, and FIG. 4.

At 508, a supply of the water may be controlled from the water supply unit 108 to the electrolyzer unit 110. The electrolyzer unit 110 is configured to split the water 402 to produce green hydrogen 114 and green oxygen 308A. In an embodiment, the processor 202 may be configured to control the supply of the water 402 from the water supply unit 108 to the electrolyzer unit 110, wherein the electrolyzer unit 110 is configured to split the water 402 to produce green hydrogen 114 and green oxygen 308A. Details associated with the electrolyzer unit 110 are provided in FIG. 1, and FIG. 4.

At 510, the ammonia reactor unit 104 may be controlled to produce the green ammonia 118 and the steam 120 at a second timestamp (T2) using the produced green hydrogen 114. The produced steam 120 is fed into the heat exchange unit 106 at the second timestamp (T2). In an embodiment, the processor 202 may be configured to control the ammonia reactor unit 104 to produce the green ammonia 118 and the steam 120 at a second timestamp (T2) using the produced green hydrogen 114, wherein the produced steam 120 is fed into the heat exchange unit 106 at the second timestamp (T2).

At 512, the ammonia storage unit 112 may be controlled to store the green ammonia 118. In an embodiment, the processor 202 may be configured to control the ammonia storage unit 112 to store the produced green ammonia 118. Control may pass to end.

Accordingly, blocks of the flowchart 500 support combinations of means for performing the specified functions and combinations of operations for performing the specified functions. It will also be understood that one or more blocks of the flowchart 500, and combinations of blocks in the flowchart 500, can be implemented by special-purpose hardware-based computer systems which perform the specified functions, or combinations of special-purpose hardware and computer instructions.

Alternatively, the apparatus 102 may include means for performing each of the operations described above. In this regard, according to an example embodiment, examples of means for performing operations may comprise, for example, the processor and/or a device or circuit for executing instructions or executing an algorithm for processing information as described above.

Various embodiments of the disclosure may provide a non-transitory computer readable medium having stored thereon computer executable instructions, which when executed by one or more processors (such as the processor 202), cause the one or more processors to carry out operations to operate an apparatus (e.g., the apparatus 102) for production of green hydrogen 114. The instructions may cause the machine and/or computer to perform operations including controlling a supply of the steam 120 from the ammonia reactor unit 104 to the heat exchange unit 106 at a first timestamp (T1). The ammonia reactor unit 104 is configured to produce green ammonia 118 and the steam 120. The operations may include controlling the heat exchange unit 106 to extract a pre-determined amount of heat from the steam 120 and transfer the extracted pre-determined amount of heat to the water supply unit 108. The operations may include controlling the water supply unit 108 to increase a temperature of the water 402 in the water supply unit 108 from a first temperature value to a second temperature value using the transferred pre-determined amount of heat. The operations may include controlling a supply of the water 402 from the water supply unit 108 to the electrolyzer unit 110. The electrolyzer unit 110 is configured to split the water 402 to produce green hydrogen 114 and green oxygen. The operations may include controlling the ammonia reactor unit 104 to produce the green ammonia 118 and the steam 120 at a second timestamp (T2) using the produced green hydrogen 114. The produced steam 120 is fed into the heat exchange unit 106 at the second timestamp (T2). The operations may include controlling the ammonia storage unit 112 to store the produced green ammonia 118 at the first timestamp (T1) and the second timestamp (T2).

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of reactants and/or functions, it should be appreciated that different combinations of reactants and/or functions may be provided by alternative embodiments without departing from the scope of the appended claims. In this regard, for example, different combinations of reactants and/or functions than those explicitly described above are also contemplated as may be set forth in some of the appended claims. Although specific terms are employed herein, they are used in a generic and descriptive sense only and not for purposes of limitation.

What is claimed:

1. An apparatus comprising:
at least one non-transitory memory configured to store computer-executable instructions; and
at least one processor configured to execute the computer-executable instructions to:
control a supply of steam from an ammonia reactor unit to a heat exchange unit at a first timestamp, wherein the ammonia reactor unit is configured to produce green ammonia and the steam;
control the heat exchange unit to extract a pre-determined amount of heat from the steam and transfer the extracted pre-determined amount of heat to a water supply unit;
control the water supply unit to increase a temperature of the water in the water supply unit from a first temperature value to a second temperature value using the transferred pre-determined amount of heat;
control a supply of the water from the water supply unit to an electrolyzer unit, wherein the electrolyzer unit is configured to split the water to produce green hydrogen and green oxygen;
control the ammonia reactor unit to produce the green ammonia and the steam at a second timestamp using the produced green hydrogen, wherein the produced steam is fed into the heat exchange unit at the second timestamp; and
control an ammonia storage unit to store the produced green ammonia.

2. The apparatus of claim 1, wherein the processor is further configured to execute the computer-executable instructions to control the electrolyzer unit to split the water to produce the green hydrogen and the green oxygen by electrolyzing the water at an electrolyzing temperature.

3. The apparatus of claim 1, further comprising an air separation unit, and wherein the processor is further configured to execute the computer-executable instructions to control the air separation unit to produce nitrogen from air, and wherein the air comprises at least one of: nitrogen, oxygen and argon.

4. The apparatus of claim 3, further comprising a nitrogen storage unit, and wherein the processor is further configured to execute the computer-executable instructions to control the nitrogen storage unit to store the produced nitrogen.

5. The apparatus of claim 4, wherein the processor is further configured to execute the computer-executable instructions to control the nitrogen storage unit to feed the stored nitrogen to the ammonia reactor unit to produce the green ammonia.

6. The apparatus of claim 1, wherein the processor is further configured to execute the computer-executable instructions to control the ammonia reactor unit to produce the green ammonia using produced nitrogen from an air separation unit and the produced green hydrogen from the electrolyzer unit.

7. The apparatus of claim 1, wherein the produced green ammonia corresponds to a primary product and the produced steam corresponds to a by-product, of the ammonia reactor unit.

8. The apparatus of claim 1, wherein the water supply unit further comprises a demineralizer unit, and wherein the processor is further configured to execute the computer-executable instructions to control the demineralizer unit to perform demineralization of the water by removing one or more impurities from the water before the supply of water from the water supply unit to the electrolyzer unit.

9. The apparatus of claim 1, wherein a temperature of the steam is decreased from a third temperature value to a fourth temperature value after the extraction of the pre-determined amount of heat to produce water, and wherein the produced water is supplied to the water supply unit.

10. The apparatus of claim 9, wherein the processor is further configured to execute the computer-executable instructions to control the water supply unit to store the produced water.

11. A method comprising:
controlling a supply of steam from an ammonia reactor unit to a heat exchange unit at a first timestamp, wherein the ammonia reactor unit is configured to produce green ammonia and the steam;
controlling the heat exchange unit to extract a pre-determined amount of heat from the steam and transfer the extracted pre-determined amount of heat to a water supply unit, wherein the steam, after the extraction of the pre-determined amount of heat, is condensed into water and fed to the water supply unit;
controlling the water supply unit to increase a temperature of the water in the water supply unit from a first temperature value to a second temperature value using the transferred pre-determined amount of heat;
controlling a supply of the water from the water supply unit to an electrolyzer unit, wherein the electrolyzer unit is configured to split the water to produce green hydrogen and green oxygen;
controlling the ammonia reactor unit to produce the green ammonia and the steam at a second timestamp using the produced green hydrogen, wherein the produced steam at is fed into the heat exchange unit at the second timestamp; and
controlling an ammonia storage unit to store the produced green ammonia.

12. The method of claim 11, further comprising controlling the electrolyzer unit to split the water to produce the green hydrogen and the green oxygen by electrolyzing the water at an electrolyzing temperature.

13. The method of claim 11, further comprising controlling an air separation unit to produce nitrogen from air, and wherein the air comprises at least one of: nitrogen, oxygen and argon.

14. The method of claim 13, further comprising controlling a nitrogen storage unit to store the produced nitrogen.

15. The method of claim 14, further comprising controlling the nitrogen storage unit to feed the stored nitrogen to the ammonia reactor unit to produce the green ammonia.

16. The method of claim 11, further comprising controlling the ammonia reactor unit to produce the green ammonia using produced nitrogen from an air separation unit and the produced green hydrogen from the electrolyzer unit.

17. The method of claim 11, wherein the produced green ammonia corresponds to a primary product and the produced steam corresponds to a by-product, of the ammonia reactor unit.

18. The method of claim 11, further comprising controlling a demineralizer unit to perform demineralization of the water by removing one or more impurities from the water before the supply of water from the water supply unit to the electrolyzer unit.

19. The method of claim 11, wherein a temperature of the steam is decreased from a third temperature value to a fourth temperature value after the extraction of the pre-determined amount of heat to produce water, and wherein the produced water is supplied to the water supply unit.

20. A non-transitory computer-readable medium having stored thereon, computer-executable instructions that when executed by a processor of an apparatus, causes the processor to execute operations, the operations comprising:
controlling a supply of steam from an ammonia reactor unit to a heat exchange unit at a first timestamp, wherein the ammonia reactor unit is configured to produce green ammonia and the steam;
controlling the heat exchange unit to extract a pre-determined amount of heat from the steam and transfer the extracted pre-determined amount of heat to a water supply unit, wherein the steam, after the extraction of the pre-determined amount of heat, is condensed into water and fed to the water supply unit;
controlling the water supply unit to increase a temperature of the water in the water supply unit from a first temperature value to a second temperature value using the transferred pre-determined amount of heat;
controlling a supply of the water from the water supply unit to an electrolyzer unit, wherein the electrolyzer unit is configured to split the water to produce green hydrogen and green oxygen;
controlling the ammonia reactor unit to produce the green ammonia and the steam at a second timestamp using the produced green hydrogen, wherein the produced steam at is fed into the heat exchange unit at the second timestamp; and
controlling an ammonia storage unit to store the produced green ammonia.
